(19) United States
(12) Patent Application Publication
(10) Pub. No.: US 2011/0194718 A1
(43) Pub. Date: Aug. 11, 2011

(54) RECEIVER TUBE WITH STRAIN RELIEF AND HEARING AID

(75) Inventors: Andreas Ratay, Erlangen (DE); Tom Weidner, Erlangen (DE)

(73) Assignee: SIEMENS MEDICAL INSTRUMENTS PTE. LTD., Singapore (SG)

(21) Appl. No.: 13/025,361

(22) Filed: Feb. 11, 2011

(30) Foreign Application Priority Data
Feb. 11, 2010 (DE) 10 2010 007 609.0

(51) Int. Cl. H04R 25/00

(52) U.S. Cl. 381/330; 381/322

(57) ABSTRACT

A receiver tube for a hearing aid has an integrated strain relief. A receiver mounted at the end of the receiver tube is normally worn in the auditory canal of a hearing aid wearer. It is pulled out of the auditory canal by pulling at the receiver tube or also separated from the receiver tube for the purpose of cleaning or exchange. Due to the tensile forces, the flexible receiver tube is stretched and elongated. This longitudinal extension may under certain circumstances amount to up to several millimeters and load or even damage the connection of the less extensible conductor to the receiver or to the hearing aid extending through the receiver tube due to tension. The novel receiver tube has a strain relief with a strain aid that is inexpensive to produce and benefitting a small diameter, has a high visual transparency and a high flexibility of the receiver tube. The receiver tube has a flexible sheathing and an electrical conductor extending through the sheathing and longitudinally displaceable therein relative to the sheathing. Without any tensile loading in the longitudinal direction, a longitudinal section of the conductor lying within the sheathing has a greater length than the longitudinal section of the sheathing surrounding it, and this longitudinal section of the conductor is freely movable transversely to the longitudinal direction within the longitudinal section of the sheathing.

### CROSS-REFERENCE TO RELATED APPLICATION

This application claims the priority, under 35 U.S.C. §119, of German patent application DE 10 2010 007 609.0, filed Feb. 11, 2010; the prior application is herewith incorporated by reference in its entirety.

### BACKGROUND OF THE INVENTION

### Field of the Invention

The invention relates to a receiver tube with integrated strain relief for a hearing device and to a hearing aid having such a receiver tube.

Hearing aids are used for treating hearing-impaired patients that are hard of hearing. In principle, they consist of a microphone forming a sound pick-up for picking up ambient sound, of a signal processing device and amplification, and of a loudspeaker. The latter is also referred to as a receiver. In the following text, the term receiver is understood to be any output signal generator of a hearing aid. The receiver generates acoustic output signals picked up by the hearing aid, processed, and conducted to the ear of the patient.

In addition to hearing aids for generating amplified acoustic signals for hearing-impaired persons, which are used for compensating for a weakened hearing capacity, usually called bad hearing, other devices can be called hearing aid, e.g. so-called tinnitus maskers. Tinnitus maskers are used for the therapy of tinnitus patients. They generate acoustic output signals depending on the respective hearing impairment, and, depending on the active principle, also on ambient noises, which signals can contribute to reducing the perception of disturbing tinnitus or other ear noises. In the following text, the term hearing aid is also understood to encompass tinnitus maskers and other such devices.

Hearing aids are known in various fundamental housing configurations. In the case of ITE (In-the-ear) hearing aids, a housing which contains all functional components including microphone and receiver is largely worn in the auditory canal. CIC (completely-in-the-canal) hearing aids are similar to the ITE hearing aids, but are worn completely in the auditory canal. In the case of BTE hearing aids (behind-the-ear), a housing with components such as battery and signal processing device is worn behind the ear and a flexible receiver tube, also called tube, conducts the acoustic output signals of a receiver from the housing to the auditory canal. RIC-BTE hearing aids (receiver-in-canal behind-the-ear) are similar to the BTE hearing aids, but the receiver is worn in the auditory canal and the flexible receiver tube conducts electrical signals, instead of acoustic signals, to the receiver which is mounted at the front at the receiver tube.

In the case of RIC-BTE hearing aids, the receiver is fixed by a so-called ear tip in the auditory canal depending on embodiment. The ear tip can consist of a soft, and therefore pleasantly wearable flexible material, for example silicone. It is constructed to be elastic and shaped in such a manner that it is supported in the auditory canal by the elastic forces. This results in a positive connection between ear tip and auditory canal which can produce a stable positioning in the auditory canal and prevent unintentional slipping out of the auditory canal. The receiver is arranged in the area of the ear tip and is positioned stably in the auditory canal by the latter. The elastic forces of the ear tip, which can have a dome-shaped contour and is therefore also called dome, must be sufficiently large for this purpose.

The receiver is occasionally taken out of the auditory canal, e.g. for cleaning, for exchanging or when the hearing aid is not to be worn. The removal is normally effected in the most simple manner by pulling the receiver tube. The tensile force must then be sufficiently large for overcoming the force with which the ear tip fixes the receiver tube and the receiver in the auditory canal. Occasionally, the ear tip is also exchanged for which purpose it is pulled off the receiver tube. Due to such tensile forces, the flexible receiver tube is stretched, more precisely elongated. This elongation may under certain circumstances amount to up to several millimeters. As soon as the tensile forces are stopped, the receiver tube reversibly resumes its original length.

The problem with the elongation of the receiver tube consisting of flexible material is that the electrical conductor extending in the receiver tube, which connects the BTE housing to the receiver, consists normally of a less ductile metal. The longitudinal extension of the receiver tube, which is considerably greater in comparison with this conductor, leads to the fact that high tensile forces can occur between the conductor and the receiver arranged at the receiver tube and connected to the conductor. And even with a much more ductile conductor, high tensile forces would occur at the joint to the receiver. Due to these tensile forces, the conductor can be torn off the receiver in the worst case.

In order to prevent the conductor from being torn off the receiver, it is known to provide an extension reserve for the conductor. For example, U.S. Pat. No. 7,217,335 B2 describes a CIC hearing aid with a two-part modular structure. Around the two modules, a flexible housing is placed and the modules are connected to electrical conductors. The electrical conductors are run S-shaped with an excess of length in order to provide for a relative movement of the modules with respect to one another. However, such a CIC hearing aid does not have a receiver tube.

It is also known to run the conductor of a BTE hearing aid loosely i.e. longitudinally displaceably in the receiver tube and to provide an extension reserve, e.g. in the form of a conductor loop, in the area of the receiver. In the case of extension of the receiver tube due to a tensile load, the conductor can move longitudinally in the tube and in doing so use the extension reserve. If the extension reserve is provided in the area of the receiver which is carried by an earpiece, it must be accommodated inside the receiver or the receiver housing or receiver connection in the earpiece. Due to the small dimensions of the earpiece and because it is connected to the receiver in a space-saving manner and without relatively large cavities or intermediate spaces, the accommodation of the extension reserve is here very complex during the production or assembly.

U.S. Pat. No. 4,727,582 describes a BTE hearing aid in which an adaptation of the length of the receiver tube is made possible by the fact that a possibly excessive longitudinal section of the receiver tube is arranged inside the housing. The longitudinal section is wound around a spindle which can be pre-stressed by a spring, depending on embodiment. This design presupposes a relatively high space requirement in the BTE housing and it is also mechanically complex. In addition, the electrical conductor extending in the receiver tube can have an extension reserve by being placed spirally around a flexible carrier core. The carrier core is longitudinally extendable due to its flexibility and the conductor is due to its spiral winding. Such a conductor plus carrier core is complex to produce and also has a relatively large diameter which counteracts the cosmetically desirable reduction in size of the receiver tube. In addition, such a conductor has an additional material core in the form of the additional flexible carrier core, which also counteracts the cosmetically desirable increase in visual transparency of the receiver tube and reduces the overall flexibility of the receiver tube in an undesirable manner.

### SUMMARY OF THE INVENTION

It is accordingly an object of the invention to provide a hearing device receiver tube and a hearing aid which overcome the above-mentioned disadvantages of the heretofore-known devices and methods of this general type and which provides for a receiver tube with strain relief and a hearing aid having such a receiver tube, wherein the tension aid is inexpensive to produce and allows for a small diameter, a high visual transparency, and a superior flexibility of the receiver tube.

With the foregoing and other objects in view there is provided, in accordance with the invention, a receiver tube for a hearing aid, comprising:

a flexible sheathing;

an electrical conductor extending through said sheathing and being displaceable therein along a longitudinal direction relative to said sheathing;

wherein, in an absence of a tensile loading in the longitudinal direction, a given longitudinal section of said conductor lying within a corresponding longitudinal section of said sheathing has a greater length than said corresponding longitudinal section of said sheathing surrounding said conductor, and said given longitudinal section of said conductor is freely movable transversely to the longitudinal direction within said corresponding longitudinal section of said sheathing.

A basic concept of the invention consists in a receiver tube for a hearing aid which comprises a flexible sheathing and an electrical conductor extending through the sheathing. The conductor is longitudinally displaceable within the sheathing and relative to the sheathing. In the case of an absence of tensile loading in the longitudinal direction (i.e., when the receiver tube is in its relaxed, non-stretched condition), a longitudinal section of the conductor lying within the sheathing has a greater length than the longitudinal section of the sheathing surrounding it, and wherein this longitudinal section of the conductor is freely movable transversely to the longitudinal direction within the longitudinal section of the sheathing.

The greater length of the conductor in comparison with the sheathing can compensate for a longitudinal extension of the sheathing in the case of tensile loading since the conductor is longitudinally displaceable in the sheathing. By this means, a tensile loading of the connection of the conductor to a connected receiver or also to electronic components of a signal processor in the housing of a hearing aid can be avoided. At the same time a simple, inexpensively implementable visually transparent and mechanically flexible construction is ensured since no additional disadvantageously acting components such as e.g. a spindle or a carrier core are required at all.

In comparison with the sheathing, the length of the conductor can be greater by several millimeters. The difference in length between the conductor and the sheathing is selected in such a manner that the longitudinal extent of the sheathing is less than the said difference in length up to a predetermined maximum tensile force. In other words, the difference in length is thus selected in such a manner that up to the predetermined maximum tensile force, the length of the sheathing becomes never greater than the length of the conductor. A suitable maximum tensile force, considering the application in hearing aids, is 10 N or less, especially 5 N. The cross-sectional area and the modulus of elasticity of the sheathing must be suitably selected in dependence on this specification. In addition, it is of advantage if the longitudinal extension of the sheathing remains within the linearly elastic range up to the desired maximum tensile force.

An advantageous development of the basic concept consists in that the longitudinal section of the conductor is preformed to be undulating or spiral. This provides a uniform preforming of the conductor which, at the same time, ensures flexible extensibility in the longitudinal direction and can be visually appealing. In addition, such preforming ensures the greatest possible flexibility and facilitates the introduction of the conductor plus excess length into the sheathing during the assembly.

In accordance with an added feature of the invention, the diameter of the lumen of the longitudinal section of the sheathing corresponds to twice to three times the diameter of the conductor. This provides an excellent compromise with regard to possible unrestricted freedom of movement especially in the transverse direction of the conductor lying inside and a least possible total diameter of the receiver tube. In this context, a greater lumen increases the freedom of movement of the conductor and thus the flexibility and, at the same time, facilitates the assembly. However, a larger total diameter reduces the overall flexibility and is visually more obvious and thus cosmetically regarded undesirable.

In accordance with an additional development of the basic concept, the longitudinal section of the sheathing extends over the entire length of the sheathing. As a result, a sheathing can be used which has a uniform cross section over its entire length. Such a sheathing is less expensive to produce than a sheathing with changing cross sections in which the longitudinal section only extends over a partial area of length of the sheathing. At the same time, it can be easily adapted individually in length in that it is cut to a respective fitting length similar to so-called yard goods.

In accordance with another feature of the invention, in the case of tensile loading in the longitudinal direction, both the sheathing of the receiver tube and the longitudinal section of the conductor lying within the sheathing are reversibly lengthened. As a result, tensile forces acting on the electrical joints of the conductor, e.g. to a receiver or hearing aid housing, are prevented. The reversible restitution after removal of the tensile forces at the same time ensures a high flexibility in use in that the original receiver tube length possibly adapted to the respective hearing aid wearer is assumed again.

In accordance with an further feature of the invention, there is provided a detachable electrical plug-in connector for connection to a hearing aid housing or to a receiver at least one end of the receiver tube. As a result, the receiver tube becomes modularly usable and also exchangeable. In addition, e.g. the receiver can also be exchanged or renewed without requiring a new receiver tube or even a new hearing aid housing.

With the above and other objects in view there is also provided, in accordance with the invention, a hearing aid having a receiver tube as outlined above.

In accordance with a concomitant feature of the invention, the hearing aid comprises a housing which is constructed for being worn behind an ear conch of a hearing aid wearer, and a receiver which is constructed for being worn in the auditory canal of the hearing aid wearer, the receiver tube connecting the receiver and the housing. By this means, an RIC-BTE hearing aid is realized as a particularly advantageous application.

Other features which are considered as characteristic for the invention are set forth in the appended claims.

Although the invention is illustrated and described herein as embodied in a receiver tube with strain relief and hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic view of a RIC-BTE hearing aid according to the prior art;

FIG. 2 is a diagrammatic view of an RIC-BTE hearing aid with a receiver tube according to the invention; and

FIG. 3 illustrates an embodiment of a receiver tube according to the invention.

### DETAILED DESCRIPTION OF THE INVENTION

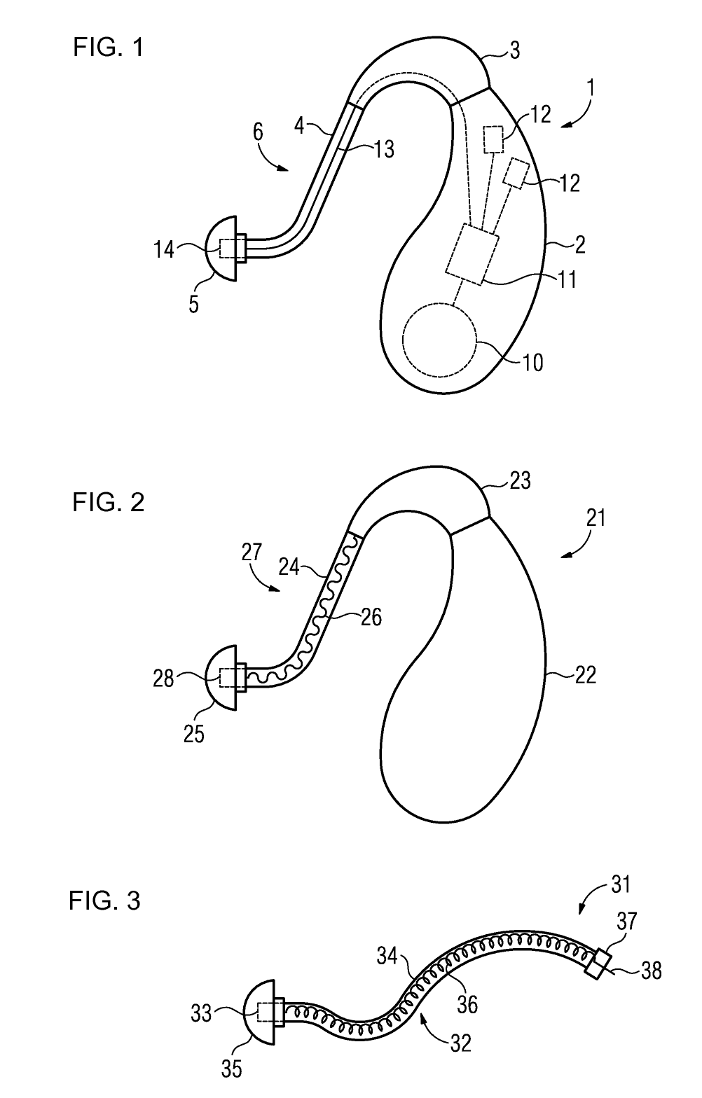

Referring now to the figures of the drawing in detail and first, particularly, to FIG. 1, there is shown a diagrammatic illustration of a prior art RIC-BTE (receiver in the canal, behind the ear) hearing aid 1.

In a housing 2, there is provided a battery 10 which supplies the electrical components with energy. The battery 10 may be rechargeable and nonchargeable. It is based on conventional battery technology e.g. zinc/air, nickel metal hydride, lithium ions, lithium polymer etc.

A signal processor 11 is used for processing acoustic input signals. It can operate in analog or, preferably, in a digital manner and, as core item, be based on a generally obtainable or individually adapted computing unit. The signal processor 11 is used for generating suitable acoustic output signals of the hearing aid 1 in dependence on a selectable hearing program and possibly on an acoustic input signal source. In the case of a hearing aid constructed as a tinnitus therapy device, an operation independent of acoustic input signals could also be considered.

Microphones 12 pick up ambient sound and convert it into input signals for the signal processing device 11. The microphones 12 are based on conventional microphone technology. Although two microphones 12 are preferably provided in order to provide for the most advantageous signal processing possible with a good signal/noise ratio and good spatial signal resolution, a single microphone 12 or a greater number can also be provided instead.

The output signals of the signal processing device 11 are supplied to a receiver 14 by an electrical conductor 13. The conductor 13 passes through the plug-in connector 3 and the receiver tube 6. The receiver tube 6 comprises a flexible sheathing 4 which is usually constructed with a small diameter and of transparent plastic. The receiver 14 is arranged at the end of the receiver tube 6 facing away from the housing 2. It is mounted in an earpiece constructed presently as dome 5.

The dome 5 is exchangeably mounted on the receiver tube 6. In normal operation of the hearing aid 1, it is worn in the auditory canal of the hearing aid wearer. To pull the dome 5 out of the auditory canal, the hearing aid wearer usually simply pulls at the receiver tube 6, also in order to separate the dome 5 from the receiver tube 6. The tensile loading acting in the longitudinal direction of the receiver tube 6 during this process, due to its flexible construction, leads to a significant longitudinal extension of the receiver tube 6. This longitudinal extension, in turn, can lead to a tensile loading of the connection between conductor 13 and receiver 14 and of the connection between conductor 13 and the components connected to the conductor 13 in the housing 2.

Referring now to FIG. 2, there is shown an RIC-BTE hearing aid 21 with receiver tube 27 according to the invention. The RIC-BTE hearing aid 21 comprises in principle the same functional components as explained above, which are therefore not all shown. The housing 22 is connected to the plug-in connector 23 to which the receiver tube 27 is joined. At the end of the receiver tube 27 facing away from the housing 22, a dome 25 plus receiver 28 arranged therein is attached.

The receiver tube 27 comprises a sheathing 24 constructed of flexible material. The sheathing may consist of a conventional material e.g. of transparent plastic. The electrical conductor 26, which can also consist of conventional materials, extends through the sheathing. The conductor 26 connects the receiver 28 to the housing 22 and the electronic components arranged therein, respectively.

The conductor 26 extends through a lumen of the sheathing 24 in which it is longitudinally displaceably arranged. The lumen has a larger diameter than the conductor 26. As a result, the conductor 26 has freedom of movement transversely to the longitudinal direction of the receiver tube 27. It is flexibly constructed and preformed to be undulating so that, as a consequence, it passes in undulating manner through the lumen in the absence of tensile forces or other external forces. This ensures good flexibility for abnormal bendings. The uniform preforming of the conductor 26 can also be perceived as aesthetically appealing.

If the receiver tube 27 is exposed to tensile loading, e.g. when the hearing aid wearer wants to pull the dome 25 out of the auditory canal or away from the receiver tube 27, the sheathing 24 extends in the longitudinal direction due to its flexibility. Although the conductor 26 is less extendable per se, it can be stretched with the effect that the undulating shape is pulled straight. To this extent, the undulating shape of the conductor 26 forms an extension reserve so that a tensile loading of the connection between conductor 26 and receiver 28 or between conductor 26 and those at the end of the conductor 26 opposite the receiver 28 is avoided.

FIG. 3 is a diagrammatic illustration of an exemplary embodiment of a receiver tube assembly 31 with strain relief according to the invention. The receiver tube assembly 31 is shown without a hearing aid. It will be readily understood that the receiver tube assembly 31 may be used with different devices or as an exchange or replacement part.

The receiver tube assembly 31 comprises a receiver tube 32 with a sheathing 34 which can be constructed as explained above of flexible and possibly transparent material, e.g. plastic. A conductor 36 which is connected to a receiver 33 used at the end of the sheathing in a dome 35 extends through the lumen of the sheathing 34. At the end of the receiver tube 32 opposite to the receiver 33, a connecting piece 37 is attached through which the receiver tube 32 can be connected to a hearing aid. The connecting piece 37 can be integrally molded with the sheathing 34 or connected thereto as a separate part. A conductor end 38 of the conductor 36 can be connected to electrical components of the hearing aid to be linked up.

The lumen in the sheathing 34 has a larger diameter than the conductor 36 passing through so that the latter has freedom of movement transversely to the longitudinal direction of the sheathing 34 inside the lumen. The conductor 36 consists of flexible materials and is spirally preformed. The spiral preforming can produce the advantageous characteristics explained above in conjunction with the undulating preformed conductor.

A basic concept of the invention can be summarized as follows: the invention relates to a receiver tube with integrated strain relief for a hearing aid and a hearing aid having such a receiver tube. A receiver mounted at the end of the receiver tube is usually worn in the auditory canal of a hearing aid wearer. It is pulled out of the auditory canal by pulling at the receiver tube or also separated from the receiver tube for the purpose of cleaning or exchange. Due to the tensile forces, the flexible receiver tube is stretched, more precisely elongated. This longitudinal extension may under certain circumstances amount to up to several millimeters and load or even damage the connection of the less extendable conductor, extending through the receiver tube, to the receiver or to the hearing aid due to tension. The object of the invention consists in specifying a receiver tube with strain relief and a hearing aid having such a receiver tube, the strain aid being inexpensive to produce and benefitting a small diameter, a high visual transparency and a high flexibility of the receiver tube. This object is achieved by the invention by means of a receiver tube (27, 32) for a hearing aid (21), comprising a flexible sheathing (24, 34) and an electrical conductor (26, 36) extending through the sheathing (24, 34) and longitudinally displaceable therein relative to the sheathing (24, 34), in the case of absence of tensile loading in the longitudinal direction, a longitudinal section of the conductor (26, 36) lying within the sheathing (24, 34) having a greater length than the longitudinal section of the sheathing (24, 34) surrounding it, and this longitudinal section of the conductor (26, 36) being freely movable transversely to the longitudinal direction within the longitudinal section of the sheathing (24, 34).

1. A receiver tube for a hearing aid, comprising:
a flexible sheathing;
an electrical conductor extending through said sheathing and being displaceable therein along a longitudinal direction relative to said sheathing;
wherein, in an absence of a tensile loading in the longitudinal direction, a given longitudinal section of said conductor lying within a corresponding longitudinal section of said sheathing has a greater length than said corresponding longitudinal section of said sheathing surrounding said conductor, and said given longitudinal section of said conductor is freely movable transversely to the longitudinal direction within said corresponding longitudinal section of said sheathing.

2. The receiver tube according to claim 1, wherein said given longitudinal section of said conductor has a preformed undulating or spiral shape.

3. The receiver tube according to claim 1, wherein a difference in length between said conductor and said sheathing is greater than a longitudinal extent of the sheathing up to a predetermined maximum tensile loading.

4. The receiver tube according to claim 3, wherein the predetermined maximum tensile loading is at most 10 N

5. The receiver tube according to claim 3, wherein the predetermined maximum tensile loading is at most 5 N.

6. The receiver tube according to claim 3, wherein a longitudinal extension of said sheathing remains within a linearly elastic range up to the predetermined maximum tensile force.

7. The receiver tube according to claim 1, wherein a diameter of a lumen in said corresponding longitudinal section of said sheathing amounts to twice to three times a diameter of said conductor.

8. The receiver tube according to claim 1, wherein said corresponding longitudinal section of said sheathing extends over an entire length of said sheathing.

9. The receiver tube according to claim 1, wherein, on occasion of tensile loading in the longitudinal direction, said sheathing and said given longitudinal section of said conductor lying within said sheathing are reversibly lengthened.

10. The receiver tube according to claim 1, which comprises a detachable electrical plug-in connector for connection to a hearing aid housing or to a receiver disposed at least one end of receiver tube.

11. A hearing aid, comprising a receiver tube according to claim 1.

12. The hearing aid according to claim 10, comprising a housing configured to be worn behind an ear of a hearing aid user, and a receiver to be disposed in an auditory canal of the hearing aid user, said receiver tube connecting said receiver with said housing.
